(19) United States
(12) Patent Application Publication
(10) Pub. No.: US 2022/0029241 A1
(43) Pub. Date: Jan. 27, 2022

(54) PRINTING NANOPOROUS ULTRATHIN MEMBRANES FOR LITHIUM-SULFUR BATTERIES

(71) Applicant: RENSSELAER POLYTECHNIC INSTITUTE, Troy, NY (US)

(72) Inventors: Miao Yu, Pittsford, NY (US); Fanglei Zhou, San Jose, CA (US); Feng Zhao, Salt Lake City, UT (US); Jinyun Liao, Herriman, UT (US)

(73) Assignee: RENSSELAER POLYTECHNIC INSTITUTE, Troy, NY (US)

(21) Appl. No.: 17/297,184

(22) PCT Filed: Nov. 26, 2019
(86) PCT No.: PCT/US19/63225

§ 371 Date: May 26, 2021

Related U.S. Application Data
(60) Provisional application No. 62/771,924, filed on Nov. 27, 2018.

(51) Int. Cl. H01M 50/411; H01M 4/58; H01M 10/0525; H01M 4/38; H01M 50/449; H01M 50/491

(52) U.S. Cl. CPC H01M 50/411; H01M 4/5815; H01M 10/0525; B82Y 30/00; H01M 50/449; H01M 50/491; H01M 4/382

(57) ABSTRACT

A method of making a composite membrane for a lithium-sulfur (Li—S) battery is described. The method includes providing a polymeric separator membrane; synthesizing a graphene oxide (GO) dispersion; and printing the GO dispersion onto at least one surface of the polymeric separator membrane. The GO coating includes a GO layer.

### CROSS REFERENCE TO RELATED APPLICATION(S)

This application claims the benefit of U.S. Provisional Application No. 62/771,924, filed Nov. 27, 2018, which is incorporated by reference as if disclosed herein in its entirety.

### FIELD

The present disclosure relates to nanoporous ultrathin membranes, in particular to, printing nanoporous ultrathin membranes for lithium-sulfur batteries.

### BACKGROUND

Lithium-Sulfur (Li—S) batteries are of interest for selected automotive applications, e.g., hybrid electric vehicles (HEVs) and/or electric vehicles (EVs). Li—S batteries have a relatively high energy density and a relatively low price compared to lithium-ion batteries. For example, Li—S batteries may provide almost three times the energy density (e.g., 2600 Watt-hours per kilogram (Wh/kg)) as existing lithium-ion batteries. Li—S batteries may operate more than 400 miles on a single charge in a passenger electric vehicle. The abundant availability of sulfur generally reduces the cost of Li—S batteries.

Without wishing to be bound by theory, one issue hindering the practical applications of Li—S batteries is the “polysulfide shuttle effect”. The shuttle effect originates from the diffusion of high order polysulfides from the cathode side to the anode side, where they react with metal lithium to form low order polysulfides and diffuse back to the cathode side without power output. The shuttle effect can result in low Coulombic efficiency and poor cyclability of Li—S batteries. Various strategies have been utilized to tackle the polysulfide-shuttle challenges. However, these approaches cannot fully overcome the polysulfide shuttle issue in conventional ether-based liquid electrolytes utilized in batteries.

Separators (e.g., separator membrane) are configured to prevent an internal short-circuit in an electrochemical cell while maintaining a diffusion pathway for ions. Celgard, a commercial separator used in some Li-ion batteries, includes a membrane with pore size on the micrometer scale, which allows the polysulfide species to migrate through easily.

Conductive carbon materials may be utilized as a coating on the separator membrane to suppress the polysulfides crossover. Various carbon materials including super-P, multiple wall carbon nanotubes (CNT), and graphene oxide (GO), GO-CNT composite, GO/PANI composite, reduced GO (rGO), and B-, N-doped rGO have been investigated. Generally, the existing coating layers may have (1) a relatively large pore size that allows polysulfide diffusion; (2) a relatively thick coating layer (1-100 μm) that may increase the resistance for Li-ion transportation and increase the total weight leading to lower energy density of Li—S cells; and (3) most of the existing coatings may be fabricated by casting or vacuum filtration approaches.

### SUMMARY

In an embodiment, there is provided a graphene oxide (GO) coating for a separator membrane of a lithium-sulfur (Li—S) battery. The GO coating includes a GO layer including a GO dispersion including a type of GO. The type of GO is selected from the group including: Type I GO corresponding to original GO prepared by a modified Hummers method, Type I GO functionalized with a carboxyl group (COOH), Type II GO corresponding to GO with enlarged structural defects etched by a nitric acid (HNO₃) oxidation, and Type III GO with reduced lateral size synthesized by ultra-sonication.

In some embodiments of the GO coating, the Type I GO functionalized with the carboxyl group is synthesized by mixing a 25 mL (milliliters) dispersion of original GO at a concentration of 2 mg/g (milligrams per gram) of deionized water with 5 mL of hydrogen bromide (HBr) at room temperature under vigorous stirring for 12 hours followed by adding 1 g of oxalic acid and stirring for 4 hours followed by washing with deionized water to remove the acid using centrifugation at 10,000 revolutions per minute (RPM).

In some embodiments of the GO coating, the Type 11 GO with enlarged structural defects is synthesized by diluting 2 mL of original GO to 1 mg/g with deionized water and mixing with a quantity of 70% r concentrated nitric acid (HNO₃) in a sealed glass vial followed by sonicating in a bath sonicator at room temperature for 1 hour followed by washing with deionized water to remove the acid using centrifugation at 10,000 revolutions per minute (RPM).

In some embodiments of the GO coating, the Type III GO with reduced lateral size is synthesized by putting a 50 mL dispersion of original GO in a glass vial and sonicating in a sonicator set at 500 Watts with a pulse on time of 30 seconds, a pulse off time of 10 seconds and a pulse amplitude 100% for a sonication duration followed by adding deionized water to a same level as at start.

In some embodiments of the GO coating, the quantity of 70% concentrated nitric acid corresponds to a ratio of GO to HNO₃, the ratio of GO to HNO3 selected from the group including 1:1, 1:2, 1:3, 1:4, and 1:5. In some embodiments of the GO coating, the sonication duration is in the range of 1 hour to 6 hours.

In an embodiment, there is provided a lithium-sulfur (Li—S) battery. The Li—S battery includes a lithium metal anode; a polysulfide cathode; and a composite membrane positioned between the lithium metal anode and the polysulfide cathode. The composite membrane includes a polymeric separator membrane and at least one graphene oxide (GO) coating layer on the polymeric separator membrane. The GO coating layer is formed by printing a GO dispersion on the polymeric separator membrane.

In some embodiments of the Li—S battery, the GO dispersion includes a type of GO. The type of GO is selected from the group including: Type I GO corresponding to original GO prepared by a modified Hummers method, Type I GO functionalized with a carboxyl group (COOH), Type II GO corresponding to GO with enlarged structural defects etched by a nitric acid (HNO3) oxidation, and Type III GO with reduced lateral size synthesized by ultra-sonication.

In some embodiments of the Li—S battery, the composite membrane includes two GO coating layers. In some embodiments of the Li—S battery, the composite membrane has a thickness less than about 20 nm (nanometers) and a pore size less than about 1 nm. In some embodiments of the Li—S battery, each GO coating layer has a thickness in the range of 7.5 nm to 60 nm. In some embodiments of the Li—S battery, the Li—S battery has a reversible capacity of greater than 1000 milliampere hours per gram (mAh/g). In some embodiments of the Li—S battery, the Li—S battery has a coulombic efficiency greater than or equal to 98%.

In an embodiment, there is provided a method of making a composite membrane for a lithium-sulfur (Li—S) battery. The method includes providing a polymeric separator membrane; synthesizing a graphene oxide (GO) dispersion; and printing the GO dispersion onto at least one surface of the polymeric separator membrane to form a GO coating. The GO coating includes a GO layer.

In some embodiments of the method, the GO dispersion includes a type of GO. The type of GO is selected from the group including: Type I GO corresponding to original GO prepared by a modified Hummers method, Type I GO functionalized with a carboxyl group (COOH), Type II GO corresponding to GO with enlarged structural defects etched by a nitric acid (HNO₃) oxidation, and Type III GO with reduced lateral size synthesized by ultra-sonication.

In some embodiments of the method, the type of GO is Type I GO functionalized with a carboxyl group (COOH) and synthesizing the GO dispersion includes mixing a 25 mL (milliliters) dispersion of original GO at a concentration of 2 mg/g (milligrams per gram) of deionized water with 5 mL of hydrogen bromide (HBr) at room temperature under vigorous stirring for 12 hours, adding 1 g of oxalic acid and stirring for 4 hours and washing with deionized water to remove the acid using centrifugation at 10,000 revolutions per minute (RPM).

In some embodiments of the method, the type of GO is Type II GO with enlarged structural defects and synthesizing the GO dispersion includes diluting 2 mL of original GO to 1 mg/g with deionized water and mixing with a quantity of 70% concentrated nitric acid (HNO₃) in a sealed glass vial, sonicating the mixture in a bath sonicator at room temperature for 1 hour and washing the mixture with deionized water to remove the acid using centrifugation at 10,000 revolutions per minute (RPM).

In some embodiments of the method, the type of GO is Type III GO with reduced lateral size and synthesizing the GO dispersion includes putting a 50 mL dispersion of original GO in a glass vial and sonicating in a sonicator set at 500 Watts with a pulse on time of 30 seconds, a pulse off time of 10 seconds and a pulse amplitude 100% for a sonication duration and adding deionized water to a same level as at start.

In some embodiments of the method, the GO coating is printed using a commercial printer and a commercial ink cartridge containing the GO dispersion. In some embodiments of the method, the GO dispersion is composed of GO and water, deionized (DI) water, organic solvent, or combinations thereof.

### BRIEF DESCRIPTION OF THE DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1A is a sketch of a cross section of a Lithium-Sulfur (Li—S) battery including a composite nanoporous ultrathin membrane consistent with several embodiments of the present disclosure;

FIG. 1B is a sketch of a cross section B-B′ illustrating a porosity of the nanoporous ultrathin membrane of FIG. 1A;

FIG. 2 is a sketch of one example printing system for printing a nanoporous dispersion onto a polymeric separator membrane to form a nanoporous coating, consistent with several embodiments of the present disclosure;

FIG. 3 illustrates a chemical structure of graphene oxide (GO) consistent with several embodiments of the present disclosure;

FIG. 4 is a flow chart illustrating a preparation procedure for Type IA GO consistent with several embodiments of the present disclosure;

FIG. 5 is a flow chart illustrating a preparation procedure for Type II and Type HA GOs consistent with several embodiments of the present disclosure;

FIG. 6 is a flow chart illustrating a preparation procedure for Type III GO consistent with several embodiments of the present disclosure;

FIG. 7 is a flow chart of nanoporous ultrathin membrane printing operations consistent with several embodiments of the present disclosure;

FIG. 8 illustrates a photograph and scanning electron micrographs (SEMs) of one example composite membrane that includes a polymeric separator membrane coated with a graphene oxide (GO) coating; and

FIG. 9 is a plot illustrating cycling performance comparing an example Li—S battery including a composite nanoporous ultrathin membrane and an example Li—S battery including a polymeric separator membrane.

### DETAILED DESCRIPTION

Generally, an apparatus, method and/or system consistent with the present disclosure includes a composite nanoporous ultrathin membrane that includes a nanoporous graphene oxide (GO) coating on a polymeric separator membrane. In an embodiment, a GO dispersion may be printed onto the polymeric separator membrane to form the composite nanoporous ultrathin membrane. As used herein, “ultrathin” corresponds to a membrane thickness of less than 100 nm. The composite nanoporous ultrathin membrane may then be included in a Li—S battery. A scalable printing method may be utilized to form nanoporous ultrathin coating on the composite membrane. The GO coating is configured to block polysulfide while allowing Li ions to permeate freely through the composite membrane and thus increase battery lifetime and cyclic performance. In some embodiments, the composite separator membrane is a nanoporous (pore size <1 nm (nanometers)) ultrathin (<20 nm) size-selective membrane, which includes the high-quality GO coating with nanofiltration performance on polymeric, e.g., polyolefin, membranes. Polyolefins may include, but are not limited to, polyethylene, polypropylene, etc. In one nonlimiting example, the polyolefin membrane may correspond to a Celgard battery separator membrane available from, Celgard®, LLC, Charlotte, N.C. However, this disclosure is not limited in this regard.

In one nonlimiting example, a GO coating having an approximately 1-nm interlayer spacing may be utilized in the composite separator membrane configured to provide selective transport of Li-ions while providing polysulfide blocking. Additionally or alternatively, the negatively charged GO coating may be configured to reject polysulfides by electrostatic repulsion and/or steric exclusion. In another nonlimiting example, an Li—S battery that includes the composite separator membrane may have a relatively high reversible capacity (>1000 mAh/g based on sulfur) with relatively high cyclability (capacity retention >85% after 1000 cycles) and relatively high coulombic efficiency (>98%).

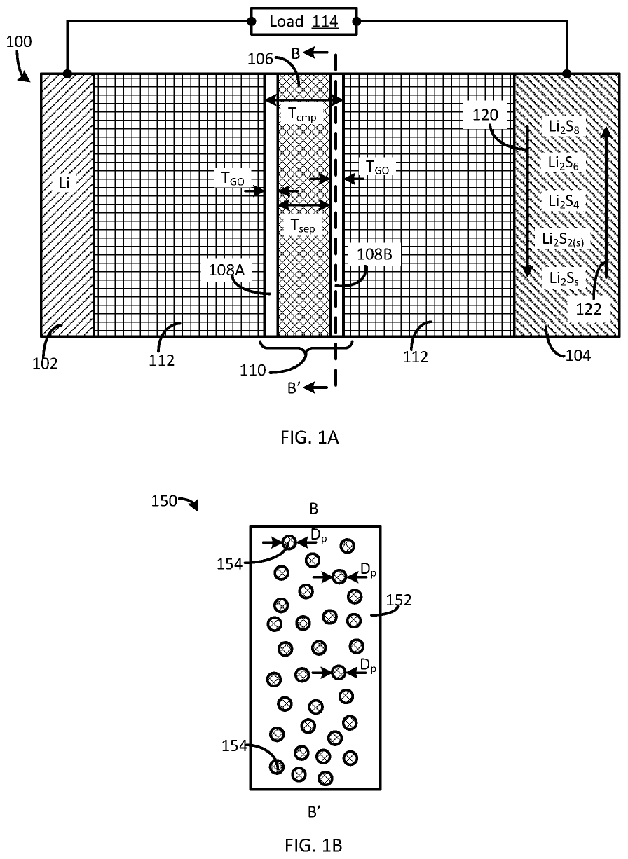

FIG. 1A is a sketch of a cross section of a Lithium-Sulfur (Li—S) battery 100 including a composite nanoporous ultrathin membrane 110 consistent with several embodiments of the present disclosure. Li—S battery 100 includes a lithium metal anode 102 and a polysulfide (i.e., “sulfur”) cathode 104. A load 114 may be coupled between the anode 102 in the cathode 104. Sketch 100 further includes arrows 120 and 122, configured to illustrate discharging direction and charging direction, respectively. Thus, a reduction in sulfur corresponds to discharging 120 and an increase in sulfur corresponds to charging 122.

Li—S battery 100 further includes the composite nanoporous ultrathin separator membrane 110 positioned between the lithium metal anode 102 and the polysulfide cathode 104. The composite nanoporous ultrathin separator membrane 110 includes a polymeric separator membrane 106 and at least one graphene oxide (GO) coating layer 108A, 108B. The GO coating layer(s) 108A, 108B, may be formed by printing a GO dispersion onto the polymeric separator membrane 106, as will be described in more detail below.

Li—S battery 100 may further include electrolyte regions 112 positioned between the lithium metal anode 102 and the composite nanoporous ultrathin membrane 110 and between the polysulfide cathode 104 and the composite nanoporous ultrathin membrane 110. The electrolyte regions 112 may contain a suitable electrolyte.

By way of example, in some embodiments, the battery 100 may include a catholyte matrix including one or more pieces of pre-activated carbon nanofiber paper (CNF). In some embodiments, the sulfur cathode 104 may be fabricated by the addition of an appropriate amount of Li₂S₆ catholyte into the binder-free carbon nanofiber electrode matrix. In some embodiments, the loading of sulfur active material may be maintained at around 3 mg/cm². In some embodiments, an Li—S battery, e.g., battery 100, may be prepared with a coin-cell configuration. After the sulfur cathode 104 is fabricated, a piece of membrane separator, e.g., composite separator membrane 110, may be put on top. Then, an amount of blank electrolyte, e.g., electrolyte 112, may be added onto the membrane 106. In some embodiments, a piece of lithium foil anode, e.g., lithium metal anode 102, may be placed on the membrane 110.

In some embodiments, the composite membrane 110 includes a polymeric membrane 106 and a graphene oxide (GO) layer/coating, e.g., GO coating 108A or 108B, in a GO/polymer configuration. In some embodiments, the composite membrane 110 includes two GO layers 108A and 108B for a GO/polymer/GO configuration. In some embodiments, the polymer 106 may be a polyolefin, e.g., polyethylene, polypropylene, etc. In one nonlimiting example, the polyolefin membrane may correspond to a Celgard battery separator membrane available from, Celgard®, LLC, Charlotte, N.C. However, this disclosure is not limited in this regard.

The polymeric separator membrane 106 has a thickness, Tₛₑₚ. The GO coating has a thickness, T_{GO}. The composite separator membrane 110 as a composite thickness, T_{cmp}. Thus, in some embodiments, the composite thickness, T_{cmp}, may correspond to Tₛₑₚ+T_{GO}, i.e., embodiments that include one GO coating layer, e.g., GO coating layer 108A or 108B. In some embodiments, the composite thickness, T_{cmp}, may correspond to Tₛₑₚ+2*T_{GO}, i.e., embodiments that include two GO coating layers, e.g., GO coating layers 108A and 108B.

In some embodiments, the composite separator membrane 110 has an overall thickness, T_{cmp}, less than about 100 nm. In some embodiments, the composite separator membrane 110 is ultrathin having a thickness, T_{cmp}, of less than 20 nm. In some embodiments, the thickness, T_{GO}, of a GO layer, e.g., GO layer 108A, is about 7 nm to about 60 nm. In some embodiments, the thickness, Tao, of a GO layer is about 20 nm. In some embodiments, the thickness, T_{GO}, of a GO layer is less than about 20 nm. The relatively thin, e.g., ultrathin, composite separator membrane 110 may enable relatively fast mass transport and relatively high gravimetric energy density of Li—S batteries, e.g., battery 100. The ultrathin composite membranes, e.g., composite membrane 110, can be fabricated by a relatively simple, relatively low-cost printing method, as described herein, and may enable scalable coating of GO layer 108A and/or 108B.

FIG. 1B is a sketch of a cross section 150 B-B′ illustrating a porosity of the composite nanoporous ultrathin membrane 110 of FIG. 1A. Cross-section 150 includes GO coating 152. The GO coating 152 defines a plurality of nanopores, e.g., nanopore 154. Each nanopore has a diameter, Dₚ. In some embodiments, the composite membrane 110 has a pore size, e.g., nanopore 154 has a diameter, Dₚ, that is less than about 10 nm. Such nanopore size is configured to block the primary contributors to the shuttling currents, i.e., lithium polysulfides Li₂Sₓ where x≥4. In some embodiments, the pore diameter, Dₚ, is about 1.2-1.7 nm. In some embodiments, the membrane is nanoporous (pore size <1 nm). Without wishing to be bound by theory, the ultrathin GO coating may be configured to effectively block polysulfide and maintain stability of Li—S battery. The composite separator membrane 110 may thus be considered to be size-selective in that the size of the pores corresponds to a size of molecules that may pass through the membrane.

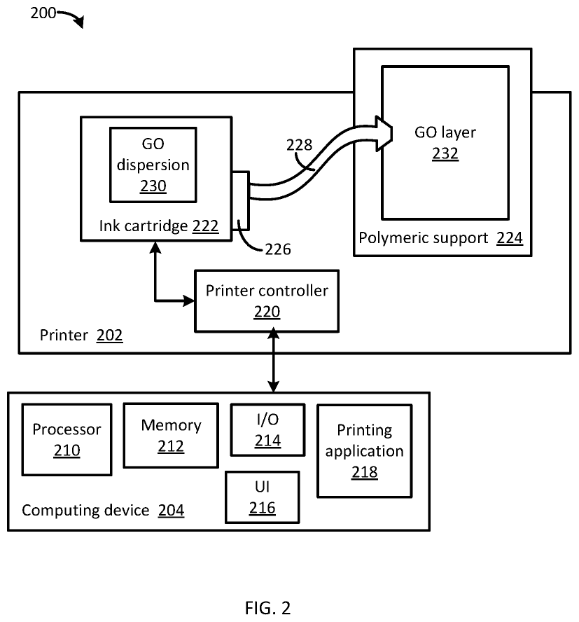

FIG. 2 is a sketch of one example printing system 200 for printing a nanoporous dispersion onto a polymeric separator membrane to form a nanoporous coating, consistent with several embodiments of the present disclosure. Printing system 200 includes a printer 202 and a computing device 204. In one nonlimiting example, the printer 202 may correspond to a commercially available inkjet printer, e.g., as may be available from Hewlett-Packard (“HP”), Epson, Brother, etc.

Computing device 204 may include, but is not limited to, a computer (e.g., desktop, laptop, portable, tablet, etc.), a smart phone, etc. Computing device 204 includes a processor 210, a memory 212, input-output (I/O) circuitry 214, a user interface (UI) 216 and a printing application 218. Processor 210 is configured to perform operations of computing device 204 and, in particular, operations of printing application 218. Memory 212 may be configured to store information related to operations of computing device 204. I/O circuitry 214 may be configured to couple computing device 204 to printer 202 and/or to a network (not shown). UI 216 is configured to provide a user access to computing device 204 and, thus, printer 202. UI 216 may thus include user input devices (e.g., keyboard, mouse, keypad, touch sensitive display, etc.) and/or user output devices (e.g., display, monitor, screen, etc.).

Printing application 218 is configured to manage printing operations of printer 202. In one nonlimiting example, printing operations may include printing a GO dispersion onto a polymeric separator membrane to form a GO coating that includes at least one GO layer. In one nonlimiting example, printing application 218 may correspond to a commercially available printing application, e.g., Photoshop®, available from Adobe®, San Jose, Calif. However, this disclosure is not limited in this regard.

Printer 202 includes a printer controller 220, an ink cartridge 222, a nozzle plate 226 and a nozzle 228. The ink cartridge 222 is configured to contain a GO dispersion 230. The printer controller 220 is configured to manage operations of printer 202 and to communicate with computing device 204. System 200 may further include a polymeric support structure 224 and a GO layer 232. The ink cartridge 222 may contain GO dispersion 230. In operation, the nozzle 228 is configured to receive GO dispersion from the ink cartridge 222 via nozzle plate 226 and to deliver the GO dispersion to the polymeric support 224 in a controlled manner. An amount of GO dispersion 230 may be controlled by printing application 218 via printer controller 220. Such control may be configured to provide flexibility in the amount of GO dispersion printed onto polymeric support 224 and thus a resulting thickness of GO layer 232.

Some embodiments of the present disclosure are directed to a method of forming the GO layer by printing a GO dispersion on a polymer separator membrane according to some embodiments of the present disclosure. In some embodiments, the GO layer may be printed using a commercial printer ink cartridge, e.g., commercial printer cartridge from HP, resolution: 1200 dots per inch, including an appropriate GO dispersion. In some embodiments, a modified printer is used to print the GO layer, e.g., a Deskjet 1112 HP. However, this disclosure is not limited in this regard. For example, the printer may be modified by removing some gears and attaching parts to ensure a uniform and non-scratch printing process. In some embodiments, a polymeric support 224 is fixed in a film, and the GO dispersion 230 is printed on the polymer support surface by the ink cartridge 222. In some embodiments, a self-evaporation-assembly operation is conducted after printing. In some embodiments, the printed GO membrane is dried for about 12 h at room temperature and then 2 h at 60° C. In some embodiments, e.g., for multi-time printing, 4 h drying at room temperature is used between printings.

In some embodiments, GO dispersion (“ink”) may be prepared by dispersing GO in water, deionized (“DI”) water, organic solvent, or combinations thereof. In one nonlimiting example, 400 mg of GO is dissolved in 100 mL (milliliters) DI water by ultrasonication for more than two hours to ensure dispersion of GO flakes in water. Then, the GO dispersion is centrifuged (5 min, 1,000 rpm) to remove any large particles or aggregates. No obvious GO concentration change, being confirmed by UV-vis measurements, should be observed before and after centrifugation, which indicates a negligible amount of GO aggregates. After that the supernatant may be collected and diluted in DI water to prepare different concentrations of GO “ink”.

Specific coating solvents, coating solution concentration, total GO loading amount, coating times, drying method (vacuum or heat), membrane post-treatment, printing times, solvent composition, and drying condition can be chosen to achieve high-quality ultrathin membranes. In some embodiments, the GO ink solvent may correspond to a selected mixture of water with organic solvent based on the hydrophilicity of the polymer support. In some embodiments, the printing parameters are controlled using printing application 218 to adjust the printing quality/resolution and the transparency.

Without wishing to be bound by theory, the coating solvent composition influences wetting of coating solution on the separator surface and GO dispersibility. By way of example, Celgard polypropylene is a super hydrophobic support and thus organic solvents may be more appropriate for GO coating, although GO has relatively the best dispersibility in water due to its super hydrophilicity. The GO thickness (e.g., <20 nm) can be controlled by changing the coating solution concentration or the total GO loading amount to obtain the thinnest coating with the best polysulfide blockage and the highest Li ion transport rate. Additionally or alternatively, different drying processes of as-coated with GO composite membranes may offer various membrane structures because the trapped solvent molecules between GO interlayers may be removed in a variety of ways, resulting in variety of d-spacings. In some embodiments, post-treatments such as thermal and chemical reduction further the membrane performance and operation stability.

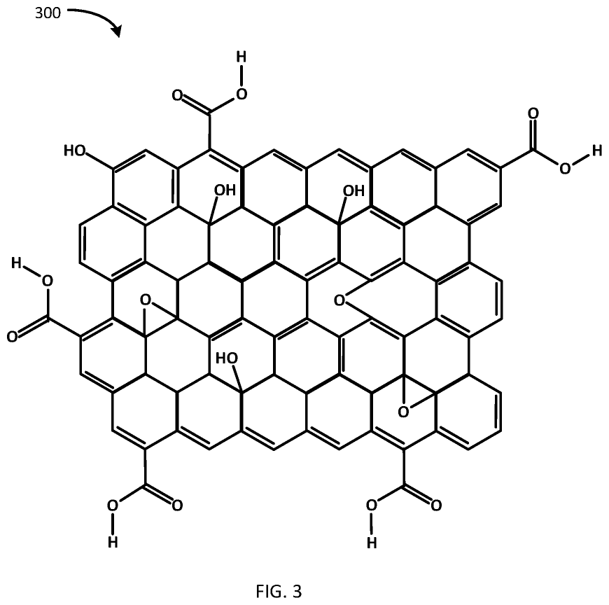

FIG. 3 illustrates a chemical structure 300 of graphene oxide (GO) consistent with several embodiments of the present disclosure. The chemical structure of GO is composed of a graphene sheet derivatized by phenyl epoxide and hydroxyl groups on the basal plane and carboxylic acid groups on the edge. Without wishing to be bound by theory, GO is an oxidized form of graphene that is made of carbon atoms bonded in hexagonal honeycomb lattice. As a two-dimensional material, GO has particular physico-chemico-mechanical properties that may be beneficial for size-selective membranes. GO may have the potential to make relatively thin membranes with a non-friction molecular transport path while providing effective molecular sieving. In one nonlimiting example, the GO membranes with lamellar structure typically present a nano-sized interlayer spacing of 0.7 to 1.2 nm.

In some embodiments, the GO may be synthesized by any suitable method. In some embodiments, the GO is synthesized by a modified Hummers method. By way of example, one gram of expandable graphite may be charged in a 1 liter (L) beaker and heated for 30 seconds (s) in a microwave oven (1,000 Watts (W)). The graphite can be further expanded to about 100 times its original volume. 20 grams of expanded graphite and 1 L of H₂SO₄ may be charged in a 5 L beaker under mechanical stirring in an ice bath (under 5° C.). Then, 50 g of KMnO₄ are slowly added and the reaction is kept at 40° C. for 3 hours (h). The temperature of the reaction is decreased to 10° C. by placing in an ice bath and 2 L of deionized (DI) water is slowly dropped into the suspension over 3 h. After that, 100 ml of H₂O₂ (30 wt. %) is added. The suspension is centrifuged and washed three times with 5% HCl solution, then repeatedly washed with DI water to completely remove the acid, followed by centrifuging at 8000 rpm until the pH of the aqueous GO suspension is 6-7. The concentration of GO may then be about 1 wt. % in total 2 kg GO suspension in DI water.

Without wishing to be bound by theory, Li-ion transport resistance is proportional to the total horizontal channel length of the GO coating (e.g., T_{GO} of FIG. 1A). To minimize the horizontal pathway length, the GO film thickness, T_{GO}, may be reduced. In some embodiments, the GO film thickness is reduced by using smaller GO flakes. In some embodiments, the GO film thickness is reduced by using GO with more structural defects. In some embodiments, GO functionalization is configured to provide relatively strong affinity or repulsion between GO flakes and targeted molecules or ions, thus leading to facilitated or impeded transport.

In some embodiments, surface functionalization, acid oxidation and ultrasonication may be used to modify GO flakes to obtain GO in different sizes, with different porosity, and with different surface functional groups. Three types of GO may be synthesized including, but not limited to, GO with COOH function groups; GO with enlarged structure defects etched by HNO oxidation; and GO with reduced lateral size by ultra-sonication as shown in Table I.

TABLE I

| GO | |
|---|---|
| type | Description |
| I | Original GO prepared by modified Hummers method |
| IA | GO-COOH (GO functionalized with COOH group) |
| II | GO with enlarged structural defects etched by HNO₃ oxidation |
| IIA | Prepared with GO:HNO₃ ratio of 1:1 |
| IIA-A | Functionalized with COOH group |
| IIB | Prepared with GO:HNO₃ ratio of 1:2 |
| IIB-A | Functionalized with COOH group |
| IIC | Prepared with GO:HNO₃ ratio of 1:3 |
| IIC-A | Functionalized with COOH group |
| IID | Prepared with GO:HNO₃ ratio of 1:4 |
| IID-A | Functionalized with COOH group |
| IIE | Prepared with GO:HNO₃ ratio of 1:5 |
| IIE-A | Functionalized with COOH group |
| III | GO with reduced lateral size by ultra-sonication |
| IIIA | Prepared by 1 hour ultra-sonication |
| IIIB | Prepared by 2 hour ultra-sonication |
| IIIC | Prepared by 3 hour ultra-sonication |
| IIID | Prepared by 4 hour ultra-sonication |
| IIIE | Prepared by 5 hour ultra-sonication |
| IIIF | Prepared by 6 hour ultra-sonication |

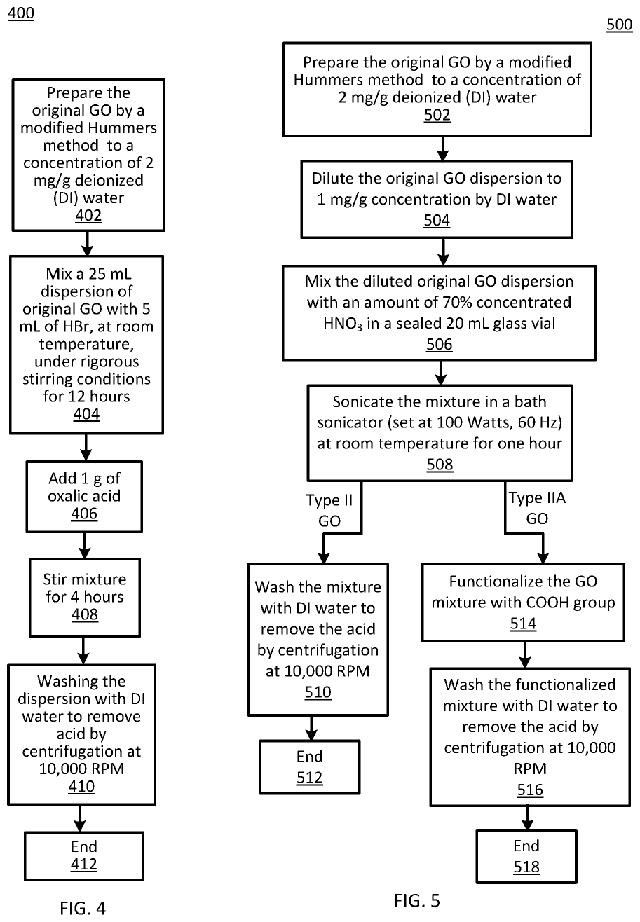

FIG. 4 is a flow chart 400 illustrating a preparation procedure for Type IA GO consistent with several embodiments of the present disclosure. As illustrated in Table I, Type IA GO corresponds to original GO functionalized with COOH group. Operations of flow chart 400 may begin with operation 402, preparing the original GO by a modified Hummers method, as described herein, to a concentration of 2 mg/g deionized (DI) water. Operation 404 includes mixing a 25 mL dispersion of original GO with 5 mL of HBr, at room temperature, under rigorous stirring conditions for 12 hours. 1 g of oxalic acid may be added at operation 406. The mixture may then be stirred for 4 hours at operation 408. Operation 410 includes washing the dispersion with DI water to remove acid by centrifugation at 10,000 RPM. Process flow may then end at operation 412.

FIG. 5 is a flow chart 500 illustrating a preparation procedure for Type II and Type IIA GOs consistent with several embodiments of the present disclosure. As illustrated in Table I, Type II GO corresponds to original GO with enlarged structural defects etched by HNO₃ oxidation and Type IIA GO corresponds to Type II GO prepared with a GO:HNO₃ ratio of 1:1. Operations of flow chart 500 may begin with operation 502, preparing the original GO by a modified Hummers method, as described herein, to a concentration of 2 mg/g deionized (DI) water. Operation 504 includes diluting the original GO dispersion to 1 mg/g concentration by DI water. Operation 506 includes mixing the diluted original GO dispersion with an amount of 70% concentrated HNO₃ in a sealed 20 mL glass vial. In an embodiment, the amount of 70% concentrated HNO₃ may be determined according to the selected ratio of GO suspension (i.e., dispersion)/70% HNO₃ volume. For example, five different concentrations of HNO₃ may be used, corresponding to GO suspension/70% HNO₃ volume ratios of 1:1 (A), 1:2 (B), 1:3 (C), 1:4 (D), and 1:5 (E). Operation 508 includes sonicating the mixture in a bath sonicator (set at 100 Watts, 60 Hz) at room temperature for one hour.

For Type II GO, operation 510 includes washing the mixture with DI water to remove the acid by centrifugation at 10,000 RPM. Process flow may then end at operation 512.

For Type IIA GO, operation 514 includes functionalizing the GO mixture with COOH group. Operation 516 includes washing the functionalized mixture with DI water to remove the acid by centrifugation at 10,000 RPM. Process flow may then end at operation 518.

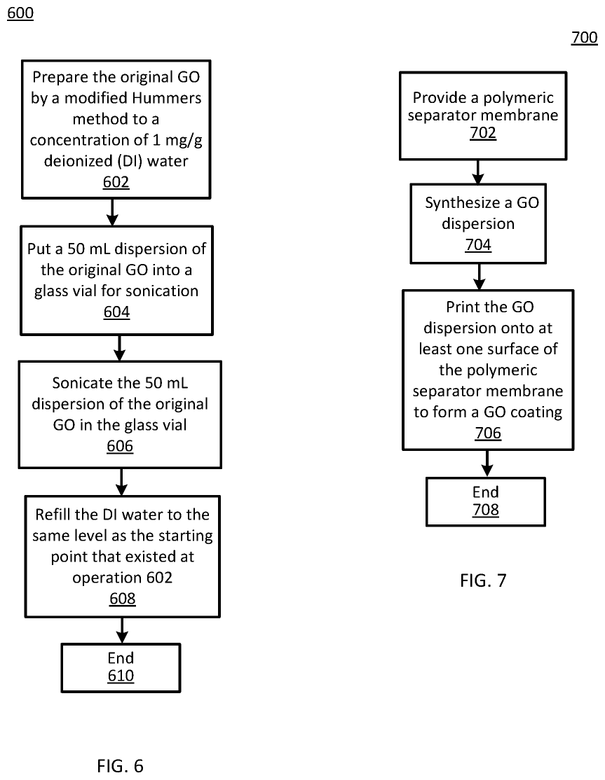

FIG. 6 is a flow chart 600 illustrating a preparation procedure for Type III GO consistent with several embodiments of the present disclosure. As illustrated in Table I, Type III GO corresponds to original GO with reduced lateral size by ultra-sonication. Operations of flow chart 600 may begin with operation 602, preparing the original GO by a modified Hummers method, as described herein, to a concentration of 1 mg/g deionized (DI) water. Operation 604 includes putting a 50 mL dispersion of the original GO into a glass vial for sonication. The 50 mL dispersion of the original GO in the glass vial may be sonicated at operation 606. In one nonlimiting example, a Q500 sonicator may be set at 500 W, pulse on for 30 s, pulse off for 10 s, and amplitude 100% for the sonication. In one nonlimiting example, for the sonication, the probe tip diameter is ½″. In an embodiment, a duration of the sonication may vary. For example, sonication duration may be in the range of 1 hour to 6 hours, corresponding to Types IIIA to F GO. Operation 608 may include refilling the DI water to the same level as the starting point that existed at operation 602. Process flow may then end at operation 610.

FIG. 7 is a flow chart 700 of nanoporous ultrathin membrane printing operations consistent with several embodiments of the present disclosure. Operations of flow chart 700 may begin with operation 702, providing a polymeric separator membrane. Operation 704 may include synthesizing a GO dispersion. Operation 706 may include printing the GO dispersion onto at least one surface of the polymeric separator membrane to form a GO coating. The GO coating may include a GO layer. Process flow may then end at operation 708. Thus, a GO coating may be printed onto a polymeric separator membrane. The GO dispersion may be synthesized, as described herein.

### Example

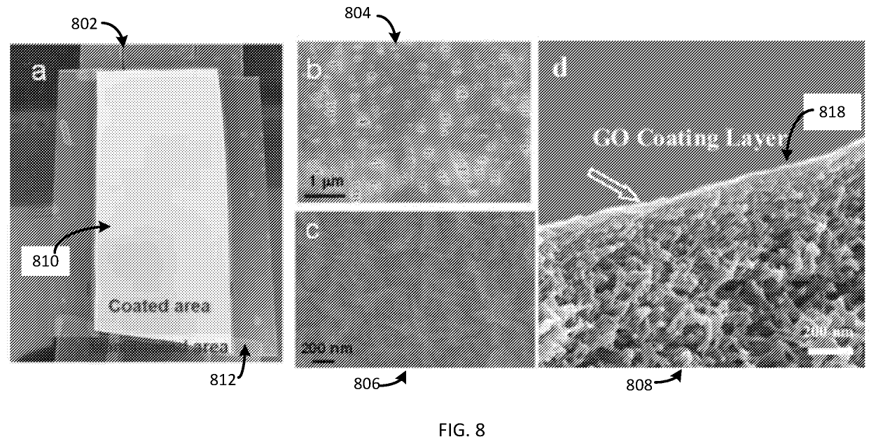

FIG. 8 illustrates a photograph 802 and scanning electron micrographs (SEM), 804, 806, 808 of one example composite membrane that includes a polymeric separator membrane coated with a graphene oxide (GO) coating. Turning first to SEM 802, a coated area 810 was printed on a polymeric (e.g., Celgard) membrane 812. The coated area exhibits a uniform color as compared to the uncoated Celgard 812 at the bottom of the photograph 802. A first SEM 804 and a second SEM 806 illustrate the microstructures of the Celgard surface 804 and well-covered Celgard by GO coating, respectively. After coating, no apparent holes or cracks can be observed at 150,000 times magnification, suggesting a structure configured to block relatively large molecules, such as polysulfides. A third SEM 808 illustrates a thickness of a GO coating layer 818. The thickness was approximately 20 nm. Thus, a GO dispersion may be printed onto a polymeric membrane to form a GO coating and may achieve in a relatively thin GO layer, consistent with the present disclosure.

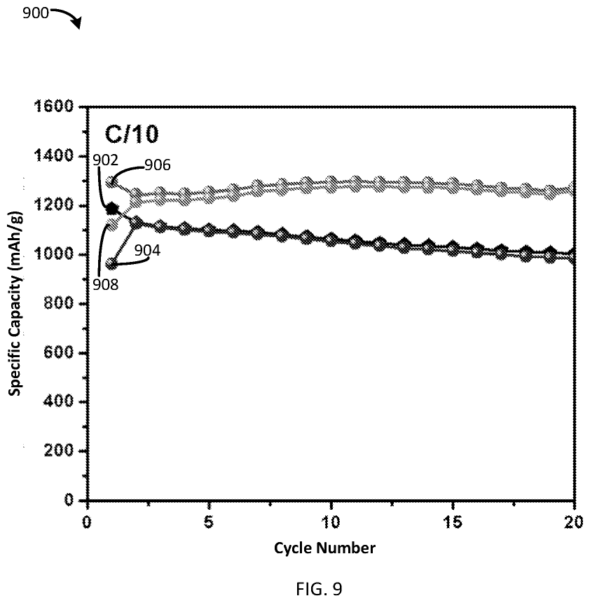

FIG. 9 is a plot 900 illustrating cycling performance comparing an example Li—S battery including a composite nanoporous ultrathin membrane and an example Li—S battery including a polymeric separator membrane. The cycling performance of Li—S batteries with uncoated Celgard separator membrane and composite GO/Celgard separator membrane (i.e., composite Celgard with GO printed coating) were measured at C/10 using Li₂S₆ cathodes (3.2 mg/cm²), respectively. In the plot 900, the horizontal axis corresponds to cycle number and the vertical axis corresponds to specific capacity in mAh/g. Plot 902 illustrates Celgard separator membrane discharge cycling performance. Plot 904 illustrates Celgard separator membrane charging cycling performance. Plot 906 illustrates composite GO/Celgard separator membrane discharge cycling performance. Plot 908 illustrates composite GO/Celgard separator membrane charging cycling performance.

The battery with the composite GO/Celgard separator membrane (Plot 906) delivered an initial discharge capacity of 1,292 mAh/g, corresponding to 78% of the theoretical maximum (1,675 mAh/g) and higher than that of plot 902 for the battery with the Celgard separator membrane (1186 mAh/g). After 20 cycles, a discharge capacity of 1,261 mAh/g was maintained for the battery with the composite GO/Celgard separator membrane (Plot 906) with a fading rate of only 0.015% per cycle. In contrast, the capacities of the battery with Celgard separator membrane decreased rapidly to 985 mAh/g. The superior cell cycling capability of the battery with composite GO/Celgard separator membrane suggests effective suppression of the polysulfide shuttle effect of the composite GO/Celgard separator membrane.

To evaluate the effect of the printed GO/Celgard membrane, a sequence of polysulfide permeation tests was performed. The GO/Celgard membranes exhibited a superior capability to block the polysulfide compared to Celgard alone. There was no color change in the blank DME/DOL solvent after 10 days, indicating no migration of the long-chain polysulfides from the upper reservoir to the opposite side through the GO/Celgard membrane. On the other hand, the dissolved polysulfides rapidly diffused through the Celgard membrane, since the colorless blank mixture DME/DOL solvent turned yellow after one hour, and turned fully dark after one day.

The Li—S batteries according to some embodiments of the present disclosure may include membranes that exhibit relatively good mechanical strength and chemical/electrochemical stability in battery operation environment. In one example, the printed GO nanofiltration membranes showed >95% rejection for representative contaminants (<1 nm in size) from pharmaceutical processes and superior performance to selected commercial nanofiltration membranes. Further, these membranes can be fabricated via a fast, scalable and cost-effective method, in part due to the utilization of ultrathin GO coating film and thus low material cost.

It is contemplated that Li—S batteries based on GO/Celgard membrane have the potential for large-scale production for HEVs and EVs. Additionally or alternatively, printed GO-based membranes may be utilized for gas separation and organic nanofiltration. The example, membranes showed selective gas molecule transport between H₂, He, CO₂ and N₂ and further separation performance improvement. Manufacturing of the thin coating film can also be integrated into roll-to-roll production line.

A barrier to the widespread adoption of renewable energy may be the lack of cost-effective, reliable distributed energy storage. It is contemplated that the Li—S battery system with high ion selective and low cost ultrathin nanoporous membranes according to some embodiments of the present disclosure may reduce greenhouse emissions by serving as a gateway technology to the widespread use of alternative and more importantly intermittent energy sources, namely wind and solar. It is further contemplated that the distributed Li—S battery technology may serve the future Smart Grid by moderating the daily fluctuations in the power grid.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A graphene oxide (GO) coating for a separator membrane of a lithium-sulfur (Li—S) battery, the GO coating comprising:
a GO layer comprising a GO dispersion comprising a type of GO, the type of GO selected from the group comprising: Type I GO corresponding to original GO prepared by a modified Hummers method, Type I GO functionalized with a carboxyl group (COOH), Type II GO corresponding to GO with enlarged structural defects etched by a nitric acid (HNO₃) oxidation, and Type III GO with reduced lateral size synthesized by ultra-sonication.

2. The GO coating of claim 1, wherein the Type I GO functionalized with the carboxyl group is synthesized by mixing a 25 mL (milliliters) dispersion of original GO at a concentration of 2 mg/g (milligrams per gram) of deionized water with 5 mL of hydrogen bromide (HBr) at room temperature under vigorous stirring for 12 hours followed by adding 1 g of oxalic acid and stirring for 4 hours followed by washing with deionized water to remove the acid using centrifugation at 10,000 revolutions per minute (RPM).

3. The GO coating of claim 1, wherein the Type II GO with enlarged structural defects is synthesized by diluting 2 mL of original GO to 1 mg/g with deionized water and mixing with a quantity of 70% concentrated nitric acid (HNO₃) in a sealed glass vial followed by sonicating in a bath sonicator at room temperature for 1 hour followed by washing with deionized water to remove the acid using centrifugation at 10,000 revolutions per minute (RPM).

4. The GO coating of claim 1, wherein the Type III GO with reduced lateral size is synthesized by putting a 50 mL dispersion of original GO in a glass vial and sonicating in a sonicator set at 500 Watts with a pulse on time of 30 seconds, a pulse off time of 10 seconds and a pulse amplitude 100% for a sonication duration followed by adding deionized water to a same level as at start.

5. The GO coating of claim 3, wherein the quantity of 70% concentrated nitric acid corresponds to a ratio of GO to HNO₃, the ratio of GO to HNO₃ selected from the group comprising 1:1, 1:2, 1:3, 1:4, and 1:5.

6. The GO coating of claim 4, wherein the sonication duration is in the range of 1 hour to 6 hours.

7. A lithium-sulfur (Li—S) battery comprising:
a lithium metal anode;
a polysulfide cathode; and
a composite membrane positioned between the lithium metal anode and the polysulfide cathode, the composite membrane comprising a polymeric separator membrane and at least one graphene oxide (GO) coating layer on the polymeric separator membrane, the GO coating layer formed by printing a GO dispersion on the polymeric separator membrane.

8. The Li—S battery of claim 7, wherein the GO dispersion comprises a type of GO, the type of GO selected from the group comprising: Type I GO corresponding to original GO prepared by a modified Hummers method, Type I GO functionalized with a carboxyl group (COOH), Type II GO corresponding to GO with enlarged structural defects etched by a nitric acid (HNO₃) oxidation, and Type III GO with reduced lateral size synthesized by ultra-sonication.

9. The Li—S battery of claim 7, wherein the composite membrane comprises two GO coating layers.

10. The Li—S battery of claim 7, wherein the composite membrane has a thickness less than about 20 nm (nanometers) and a pore size less than about 1 nm.

11. The Li—S battery of claim 7, wherein each GO coating layer has a thickness in the range of 7.5 nm to 60 nm.

12. The Li—S battery of claim 7, wherein the Li—S battery has a reversible capacity of greater than 1000 milliampere hours per gram (mAh/g).

13. The Li—S battery of claim 7, wherein the Li—S battery has a coulombic efficiency greater than or equal to 98%.

14. A method of making a composite membrane for a lithium-sulfur (Li—S) battery, the method comprising:
providing a polymeric separator membrane;
synthesizing a graphene oxide (GO) dispersion; and
printing the GO dispersion onto at least one surface of the polymeric separator membrane to form a GO coating, the GO coating comprising a GO layer.

15. The method of claim 14, wherein the GO dispersion comprises a type of GO, the type of GO selected from the group comprising: Type I GO corresponding to original GO prepared by a modified Hummers method, Type I GO functionalized with a carboxyl group (COOH), Type II GO corresponding to GO with enlarged structural defects etched by a nitric acid (HNO₃) oxidation, and Type III GO with reduced lateral size synthesized by ultra-sonication.

16. The method of claim 15, wherein the type of GO is Type I GO functionalized with a carboxyl group (COOH) and synthesizing the GO dispersion comprises mixing a 25 mL (milliliters) dispersion of original GO at a concentration of 2 mg/g (milligrams per gram) of deionized water with 5 mL of hydrogen bromide (HBr) at room temperature under vigorous stirring for 12 hours, adding 1 g of oxalic acid and stirring for 4 hours and washing with deionized water to remove the acid using centrifugation at 10,000 revolutions per minute (RPM).

17. The method of claim 15, wherein the type of GO is Type II GO with enlarged structural defects and synthesizing the GO dispersion comprises diluting 2 mL of original GO to 1 mg/g with deionized water and mixing with a quantity of 70% concentrated nitric acid (HNO₃) in a sealed glass vial, sonicating the mixture in a bath sonicator at room temperature for 1 hour and washing the mixture with deionized water to remove the acid using centrifugation at 10,000 revolutions per minute (RPM).

18. The method of claim 15, wherein the type of GO is Type III GO with reduced lateral size and synthesizing the GO dispersion comprises putting a 50 mL dispersion of original GO in a glass vial and sonicating in a sonicator set at 500 Watts with a pulse on time of 30 seconds, a pulse off time of 10 seconds and a pulse amplitude 100% for a sonication duration and adding deionized water to a same level as at start.

19. The method of claim 14, wherein the GO coating is printed using a commercial printer and a commercial ink cartridge containing the GO dispersion.

20. The method of claim 14, wherein the GO dispersion is composed of GO and water, deionized (DI) water, organic solvent, or combinations thereof.
